(19) United States
(12) Patent Application Publication
(10) Pub. No.: US 2012/0238685 A1
(43) Pub. Date: Sep. 20, 2012

(54) REINFORCED POLYMER COMPOSITE

(75) Inventors: Tom Baekelandt, Dadizele (BE); Alain Leplae, Moorsele (BE); Albert Somers, Oostende (BE)

(73) Assignee: NV BEKAERT SA

(21) Appl. No.: 13/512,691

(22) PCT Filed: Nov. 23, 2010
(86) PCT No.: PCT/EP10/68017

§ 371 Date: May 30, 2012

(30) Foreign Application Priority Data
Dec. 1, 2009 (EP) 09177614.6

(51) Int. Cl. C08K 3/08; B29B 13/00; C08L 23/00

(52) U.S. Cl. 524/439; 428/379; 264/135

(57) ABSTRACT

A reinforced polymer composite comprises a matrix of thermoplastic material, and the matrix is reinforced by at least one elongated metal element. The elongated metal element before being embedded in the matrix is coated with at least a first layer and a second layer, and the first layer comprises an adhesion promoting layer, and the second layer comprises a polyolefm copolymerized or grafted with at least one monomer comprising an anhydride or a carboxylic acid functional group. The rein-forced polymer composite further comprises wood particles with concentration of 0% to 95% by weight. It also relates to a method to manufacture the reinforced polymer composite.

### TECHNICAL FIELD

The present invention relates to a reinforced polymer composite. It also relates to a method to manufacture the reinforced polymer composite. It further relates to an elongated metal element to reinforce the composite.

### BACKGROUND ART

Reinforced polymer composites and in particular wood polymer composites (WPC) are widely used for structural application. WPC is a composite comprising wood and polymer. For structural application, reinforced polymer composite for example WPC is used in wall paneling for houses, optically closed fencing, terrace flooring or garden house etc. But it is not available for load bearing application in construction because it is subject to creep and heavy sagging under heavy load.

To increase the stiffness and creep resistance of the composite, steel wire or steel cable is embedded in the composite.

WO2004/083541 discloses a composite material comprising a matrix of thermoplastic synthetic polymer material and wood particles or cellulose-containing particles, and being embedded with steel wire or steel cable. The steel wire or steel cable is used as a reinforcement element. Before being embedded into the matrix, a thin layer of modified polymer is applied on the steel wire or steel cable. The modified polymer interacts with both the matrix and the steel wire or steel cable. The modified polymer can be polypropylene. The drawback is that the reinforcement element can be pulled out of the composite very easily. On the other hand, the steel wire or steel cable can not be embedded firmly in the matrix, since the adhesion between the reinforcement element and matrix is poor. Thus the load bearing structure is not stable when it is reinforced by such composite material.

WO 2009/082350 discloses a polymer/natural fiber composite pellet using a coupling agent to increase the compatibility between the polymer and the natural fibers. The coupling agent is selected from maleic anhydride, maleic anhydride modified polymer, compounds with mono- or multi-functional reactive nitrogen groups and silanes. The natural fibers which are longer than the commonly used sawdust and milling tailings are used to improve the reinforcement of the composite pellet. The natural fibers are cotton, hemp, jute, flax, ramie, sisal or cellulosic wood fibers. Due to its own character of the natural fiber, the composite pellet can not be stiff enough to be used for load bearing application to bear weight and force.

### DISCLOSURE OF INVENTION

It is an object of the present invention to overcome the drawbacks of the prior art.

It is also an object of the present invention to provide a reinforced polymer composite with a good adhesion between the composite and its reinforcement. More particularly it is an object of the present invention to provide a reinforced wood polymer composite.

It is another object of the present invention to provide a method to manufacture the reinforced polymer composite, in particular the reinforced wood polymer composite.

It is a further object of the present invention to provide an elongated metal element to reinforce the polymer composite, in particular the reinforced wood polymer composite.

According to the present invention, a reinforced polymer composite comprises a matrix of thermoplastic material, and the matrix is reinforced by at least one elongated metal element. The elongated metal element before being embedded in the matrix is coated with at least a first layer and a second layer. The first layer comprises an adhesion promoting layer, and the second layer comprises a polyolefin copolymerized or grafted with at least one monomer comprising an anhydride or a carboxylic acid functional group.

The reinforced polymer composite further comprises wood particles with a concentration of 0% to 95% by weight. The concentration of wood particles is between 0% and 95% by weight. Preferably the concentration of wood particles is between 20% and 80% by weight. More preferably the concentration of wood particles is between 35% and 80% by weight. Most preferably the concentration of wood particles is between 70% and 80% by weight. Here ‘% by weight’ means the weight percentage while the total weight is the weight of reinforced polymer composite.

To adhere well with the matrix, the elongated metal element is coated with at least a first layer and a second layer before being embedded into the matrix. Due to the two layers, the elongated metal element is firmly embedded into the matrix.

The first layer comprises an adhesion promoting layer such as a silicon based coating, a titanium based coating or a zirconium based coating.

According to the present invention, ‘silicon based coating’ means any coating comprising silicon. Preferably the silicon based coating comprises a silane based coating.

To the present invention, ‘silane based coating’ refers to any coating comprising an organofunctional silane. Preferably the silane based coating has the following formula:

Y′—R′—SiX′3
Wherein,
SiX′3 comprises a first functional group;
R′ comprises a spacer;
Y′ comprises a second functional group.

The first functional group SiX′3 is capable of binding to the elongated metal element.

X′ represents a silicon functional group which is independently selected from the group consisting of —OH, —R, —OR, —OC(═O)R and the halogens such as —Cl, —Br, —F, wherein —R is an alkyl, preferably a C₁-C₄ alkyl, most preferably —CH₃ and —C₂H₅.

The second functional group Y′ is capable of binding or interacting with at least one functional group of the modified polyolefin. Preferably Y′ is selected from the group consisting of —NH₂, —NHR′, —NR′, an unsaturated terminal double or triple carbon-carbon group, an acrylic, methacrylic acid group and its methyl or ethyl esters, —CN, —SH, an isocyanate group, a thiocyanate group and an epoxy group.

According to the present invention, ‘titanium based coating’ means any coating comprising titanium. Preferably the titanium based coating comprises a titanate.

According to the present invention, ‘zirconium based coating’ means any coating comprising zirconium. Preferably the zirconium based coating comprises a zirconate.

The thickness of the first layer is preferably no more than 1 μm, more preferably the thickness of the first layer ranges from 5 nm to 1000 nm, most preferably the thickness of the first layer ranges from 5 nm to 200 nm.

The second layer is applied on top of the first layer of the elongated metal element. It is used to improve the adhesion between the first layer and the matrix of thermoplastic material. For the purpose, the second layer comprises a modified polyolefin: copolymerized or grafted polyolefin. Furthermore the modified polyolefin is a polyolefin copolymerized or grafted with at least one monomer, and the monomer comprises an anhydride or a carboxylic acid functional group. The second layer interacts well with the thermoplastic material in the matrix.

WO 99/20682 describes that the metal element for reinforcing polymer product can be coated with a monolayer based on bifunctional coupling agent of silanes for good adhesion, and the metal element can be further coated with non-modified polyolefin layer, i.e. polyethylene, polypropylene or polybutadiene, upon the monolayer. The adhesion between the metal element coated with amino silane and non-modified polyolefin, i.e. non-modified polyethylene or non-modified polypropylene, and the matrix of polymer is measured by POF test. POF test is used for measuring the force to pull out metal element from the polymer matrix. The POF test result shows that the adhesion between the metal element coated with amino silane and non-modified polyolefin and the matrix of polymer is very poor that the metal element is pulled out from the matrix of polymer very easily. According to the result of adhesion test, the polyolefin layer being non-modified polyolefin in WO 99/20682 can not bring extra adhesion effect to the metal element coated with monolayer to polymer product. In other words, the adhesion to polymer product of metal element coated with monolayer and non-modified polyolefin layer is similar as or even worse than the adhesion of metal element coated with monolayer. Non-modified polyolefin gives no adhesion with silane.

Compared with WO 99/20682, the present invention improves the second layer from non-modified polyolefin into modified polyolefin. The anhydride or a carboxylic acid functional group copolymerized or grafted polyolefin layer brings a good advantage of adhesion between the metal element coated with adhesion promoting layer and polymer composite. The adhesion to matrix of thermoplastic material of the metal element coated with adhesion promoting layer and anhydride or a carboxylic acid functional group copolymerized or grafted polyolefin layer is much better than the metal element coated with adhesion promoting layer and non-modified polyolefin layer. The modified polyolefin in the present invention presents great improved adhesion between promoting layer, such as silicon based coating, a titanium based coating or a zirconium based coating, and thermoplastic material in the matrix. The two layers of promoting layer and anhydride or a carboxylic acid functional group copolymerized or grafted polyolefin layer bring improved adhesion between elongated metal element and thermoplastic material in the matrix.

Preferably, the anhydride comprises acid anhydride. More preferably, the anhydride comprises maleic anhydride.

The carboxylic acid functional group comprises preferably an acrylic acid functional group.

The thickness of the second layer is determined by the requirement of the adhesion between the first layer and the matrix of the thermoplastic material. Preferably the thickness of the second layer ranges from 10 μm to 100 μm, and more preferably the thickness of the second layer ranges from 30 μm to 50 μm.

According to the present invention, the polyolefin is preferably selected from the polyethylene or polypropylene.

Due to the two layers coating, it presents a good adhesion between the elongated metal element and the matrix of thermoplastic material, thus the elongated metal element is embedded well into the matrix.

For the purpose of the invention, an elongated metal element can be a metal wire, or a metal cord, such as a steel wire or a steel cord.

A ‘metal wire’ means a metal filament with any kind of cross-section and with any diameter. Preferably the steel wire is a round steel wire or flat steel wire. Also profiled wire can be considered.

For the purpose of this invention, ‘a metal cord’ is defined as a structure composed of two or more filaments or a combination of strands or filaments and strands.

Examples of steel cords are steel cords with the following construction 1+6, 2+7, 3+9, 4+6, 3×1, 7×1 or 1+6+12.

A ‘strand’ is defined as a group of filaments combined together to form a unit product for further processing.

The description of the construction follows the sequence of manufacturing of the cord i.e. starting with the inner most filament or strand and moving outwards. The full description of the cord is given by the following formula:

(N×F)+(N×F)+(N×F)

whereby N=number of strands;
F=number of filaments.
(when N or F equals 1, they should not be included)

Any metal can be used to provide the elongated metal elements. Preferably, alloys such as high carbon steel alloys, low carbon steel alloys or stainless steel alloys are used.

The elongated metal element can be uncoated or be coated with a suitable coating before being applied with the first layer. Such suitable coating may be zinc or zinc alloy coating, for example zinc brass coating, zinc aluminum coating or zinc aluminum magnesium coating. Such coating can prevent the corrosion of the elongated metal element from the water or acid while it can also improve the adhesion between the elongated metal element and the first layer.

Due to the reinforcement of the elongated metal element, the polymer composite has a good stiffness and creep resistance.

According to a particular embodiment of the present invention, the reinforced polymer composite is mixed with wood particles. The wood particles in the reinforced polymer composite improve the E-modulus of composite. The wood particles interact well with the thermoplastic material, so the E-modulus of the composite is high. Additionally the wood particles provide a natural appearance of the final product which can be made to look like wood.

According to the present invention, thermoplastic material is preferably a polymer selected from the group consisting of polyolefin, copolymerized polyolefin, grafted polyolefin or a combination thereof. Preferably the copolymerized or grafted polyolefin is the polyolefin copolymerized or grafted with at least one monomer comprising an anhydride or a carboxylic acid functional group.

Preferably the thermoplastic material is the same as the material of the second layer.

According to a second aspect of the present invention, a method of manufacturing a reinforced polymer composite is provided.

The method comprises the following steps:
providing at least one elongated metal element;
applying a first layer on the elongated metal element, the first layer comprises an adhesion promoting layer;
applying a second layer on top of the first layer, the second layer comprises a polyolefin copolymerized or grafted with at least one monomer comprising an anhydride or a carboxylic acid functional group;
embedding at least one elongated metal element coated with the first layer and the second layer into the matrix of a thermoplastic material.

Preferably, the matrix of a thermoplastic material is mixed with wood particles before being embedded with metal element. The concentration of wood particles is between 0% and 95% by weight.

The first layer and the second layer can be applied by any technique known in the art.

Preferably the first layer is applied by dipping the elongated metal element into the adhesion promoting agent bath. Subsequently, the coated elongated metal element can be dried.

Preferably the second layer is applied upon the first layer by applying the molten polyolefin which is copolymerized or grafted with at least one monomer comprising an anhydride or a carboxylic acid functional group under high pressure onto the elongated metal element through an extrusion die, or by coating with a solution or emulsion of the polyolefin which is copolymerized or grafted with at least one monomer comprising an anhydride or a carboxylic acid functional group on the elongated metal element and subsequently drying said coating.

Furthermore the method of manufacturing the reinforced polymer composite may comprise drying, curing, forming and/or cutting to get the desired profile in cross-section for market or customers.

According to another purpose of the invention, an elongated metal element is provided to be used for reinforcing the polymer composite. The elongated metal element is coated with at least a first layer and second layer, the first layer comprises an adhesion promoting layer, and the second layer comprises a polyolefin copolymerized or grafted with at least one monomer comprising an anhydride or a carboxylic acid functional group.

The first layer comprises an adhesion promoting layer comprising a silicon based coating, a titanium based coating or a zirconium based coating.

The second layer comprises a polyolefin copolymerized or grafted with at least one monomer, and the monomer comprises an anhydride or a carboxylic acid functional group. Preferably the polyolefin is polypropylene or polyethylene.

The elongated metal element can be uncoated or be coated with a suitable coating before being applied with the first layer. Such suitable coating may be zinc or zinc alloy coating, for example zinc brass coating, zinc aluminum coating or zinc aluminum magnesium coating. Such coating can prevent the corrosion of the elongated metal element from the water or acid and improve the adhesion between the elongated metal element and the first layer.

Due to the good adhesion between the elongated metal element and the matrix of the thermoplastic material and good reinforcement of elongated metal element, the reinforced polymer composite is stiff and stable enough to be used for loading bearing application, especially for housing, the telephone poles, window and door frames, scaffold boards, shore reinforcement etc. Furthermore the reinforced polymer composite is made into such profile with multiple hollow sections, particularly having thin walls. The high stiffness of the polymer composite leads to higher elastic stability of the partitions between the multiple cavities that are loaded at pressure and shearing.

‘Load bearing’ means bearing weight and force.

The reinforced polymer composite may have the shape of I-profile, H-profile, or any other profile comprising a body and legs or arms in cross section. Additionally the reinforced polymer composite may have the shape of tubular profile, multiple tubular profile, hollow profile, or multiple hollow in cross section.

In the present invention, ‘% by weight’ means weight percentage while the total weight is the weight of reinforced polymer composite.

### BRIEF DESCRIPTION OF FIGURES IN THE DRAWINGS

FIG. 1 shows a sectional view of a prior art round steel wire without any layer;

FIG. 2 shows a sectional view of a round steel wire with a first layer and a second layer;

FIG. 3 shows a sectional view of a flat steel wire with a first layer and a second layer;

FIG. 4 shows a sectional view of a 7×1 steel cord with a first layer and a second layer;

FIG. 5 shows a sectional view of a 7×1 steel cord with a first layer;

FIG. 6 shows a sectional view of I profile of the reinforced polymer composite;

FIG. 7 shows a sectional view of tubular profile of the reinforced polymer composite.

### MODE(S) FOR CARRYING OUT THE INVENTION

The round steel wire is manufactured as follows:

The wire rod composition has preferably a carbon content ranging between a minimum carbon content of 0.60% and a maximum carbon content of about 1.10%, a manganese content ranging from 0.40% to 0.70%, a silicon content ranging from 0.15% to 0.30%, a maximum sulphur content of 0.03%, a maximum phosphorus content of 0.30%, all percentages being weight percentage wherein the total weight is the weight of wire rod. Usually there are only traces of copper, nickel, aluminium, titanium, and nitrogen and/or chromium, except for very high tensile strengths.

The wire rod is firstly cleaned by mechanical descaling and/or by chemical pickling in a H₂SO₄ or HCl solution in order to remove the oxides present on the surface. The wire rod is then rinsed in water and is dried. The dried wire rod is then subjected to a first series of dry drawing operations in order to reduce the diameter until a first intermediate diameter.

At this first intermediate diameter, e.g. at about 3.0 to 3.5 mm, the dry drawn steel wire is subjected to a first intermediate heat treatment, called patenting. The steel wire is then ready for further mechanical deformation.

Thereafter the steel wire is further dry drawn from the first intermediate diameter until a second intermediate diameter in a second number of diameter reduction steps. The second diameter typically ranges from 1.0 mm to 2.5 mm.

At this second intermediate diameter, the steel wire is subjected to a second patenting treatment to allow for transformation to pearlite.

Additionally, after this second patenting treatment, the steel wire can be provided with a zinc coating or zinc alloy coating.

Then steel wire (with or without additional zinc or zinc alloy coating) is subjected to a final series of cross-section reductions by means of wet drawing machines to obtain the pre-determined diameter.

Possibly the steel wire is oil tempered steel wire.

Possibly one round steel wire goes through one or more adapted forming profile dies to obtain a flat steel wire or other profiled wire, such as oval profiled, I-profiled, or H-profiled wire.

Possibly several steel wires, round and/or flat steel wires, go through the twisting machine to get the steel cord.

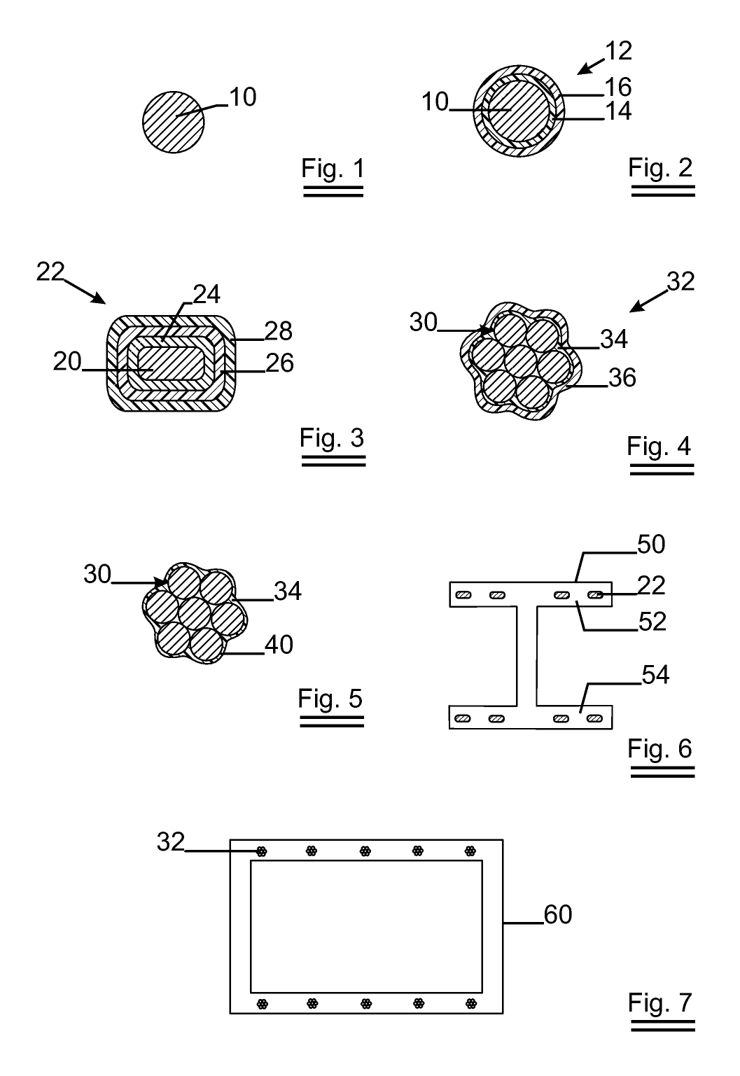

FIG. 1 illustrates a round steel wire 10 without any layer as known from the prior art.

FIG. 2 illustrates a steel wire 12 comprising a bare steel wire 10 and a first layer 14 and a second layer 16. The first layer 14 comprises an amino silane coating. The second layer 16 comprises a maleic anhydride grafted polypropylene coating.

The first layer 14 is applied on the steel wire 10 by dipping the cord in a solution comprising an amino silane followed by drying. The second layer 16 is applied upon the first layer 14 by applying molten maleic anhydride grafted polypropylene with high temperature through an extrusion die.

FIG. 3 illustrates a flat steel wire 22 comprising a bare steel wire 20 and a first layer 26 and a second layer 28. The first layer 26 comprises an amino silane coating, and the second layer 28 comprises an acrylic acid functional group copolymerized polypropylene coating. The steel wire 20 is coated with a zinc coating 24 before being applied with the first layer coating 26.

The first layer 26 is applied on the zinc coating 24 by dipping the wire in a solution comprising an amino silane followed by drying. The second layer 28 is applied upon the first layer 26 by applying molten acrylic acid functional group copolymerized polypropylene with high temperature through an extrusion die. Additionally the steel wire 22 can be dried after extrusion.

FIG. 4 illustrates a steel cord 32 with a structure of 7×1 comprising a bare steel cord 30 which is consisting of seven steel filaments with the diameter of 0.35 mm, a first layer 34 and a second layer 36. The first layer 34 comprises an amino silane coating, and the second layer 36 comprises a maleic anhydride grafted polypropylene coating.

The first layer 34 is applied on the bare steel cord 30 by dipping the cord in a solution comprising amino silane followed by drying. The second layer 36 is applied upon the first layer 34 by applying molten maleic anhydride grafted polypropylene with high temperature through an extrusion die.

FIG. 5 illustrates a prior art steel cord 40 with a structure of 7×1 comprising a bare steel cord 30 and a first layer 34.

The first layer 34 is applied on the bare steel cord 30 by dipping the cord in a solution comprising amino silane then drying.

Then the reinforced polymer composite is manufactured. A matrix of thermoplastic material, such as polyolefin, copolymerized polyolefin, grafted polyolefin or combination thereof can be mixed with wood particles. If the wood particles are added, they are added in a concentration ranging between 0% and 95% by weight, for example in a concentration of more than 35% by weight, more particularly in a concentration ranging between 70%-80% by weight. The wood particles are preferably dried till their moisture is less than 1% (here 1% is the weight percentage while the total weight is the weight of wood particles) before being mixed into the matrix. Then at least an elongated metal element comprising at least two layers, such as steel wire 12, steel wire 22 or steel cord 32, is embedded into the matrix. Then the matrix is cooled to obtain the reinforced polymer composite. Furthermore the reinforced polymer composite can be formed into the desired profile and cut into the desired length according to the requirement of the transport and the customer. The detailed description has been disclosed in patent application WO2004/03541.

The adhesion between the elongated metal element and the polymer composite is measured by determining the pull out force (POF). The length of the elongated metal element embedded (embedment length) in the polymer composite is determined. The forces necessary to pull out the elongated metal element from the polymer composite are measured. The bigger the value of POF is, the better the adhesion is.

The adhesion of the two layer coated steel wire 12 and prior art steel wire 10 to the reinforced polymer composite are compared. Table 1 summarizes the results.

TABLE 1

| | prior art steel wire | |
|---|---|---|
| elongated metal element | 10 | steel wire 12 |
| embedment length (mm) | 25 | 25 |
| POF/(POF of prior art steel wire 10) | 1 | 11.6 |

According to Table 1, compared with the pull out force between the prior art steel wire 10 and the polymer composite, the pull out force between the two layer coated steel wire 12 and the polymer composite is increased a lot. In other words, the adhesion between the two layers coated elongated metal element and the polymer composite is better than the adhesion between the elongated metal element without any coating and the polymer composite.

The adhesion of the two layer coated steel cord 32, prior art steel cord 40, prior art steel cord 30 and prior art steel cord 70 to the reinforced polymer composite comprising polypropylene as thermoplastic material are compared. The prior art steel cord 70 is a steel cord coated with amino silane coating as first layer and polypropylene coating as second layer. Table 2 summarizes the results.

TABLE 2

| | prior art | prior art | prior art | |
|---|---|---|---|---|
| elongated metal | steel cord | steel cord | steel cord | steel cord |
| element | 30 | 40 | 70 | 32 |
| embedment length | 12.7 | 12.7 | 12.7 | 12.7 |
| (mm) | | | | |
| POF/(POF of prior art | 1 | 1.78 | 1.11 | 24.17 |
| steel cord 30) | | | | |

According to Table 2 it is clear that by using the two layers coated steel cord 32 according to the present invention a strong improvement in adhesion between the steel cord and the matrix of thermoplastic material is obtained. Compared with prior art steel cord 30 (a steel cord without any coating) the adhesion between the thermoplastic material and the steel improved with a factor of more than 20.

Prior art steel cord 40, a steel cord coated with one layer (an amino silane), shows a poor adhesion with the thermoplastic material. For prior art steel cord 70, a steel cord with an amino silane coating as first layer and a polypropylene (non-modified polypropylene) coating as second layer, very poor adhesion between the steel and the thermoplastic material is obtained. The adhesion between prior art steel cord 70 and the thermoplastic material is even worse than the adhesion between prior art steel cord 40 and the thermoplastic material.

From Table 2 it can be concluded that an amino silane coating or a combination of an amino silane coating in combination with a non-modified polypropylene coating gives no or very poor adhesion between the steel cord and the thermoplastic material.

Furthermore from Table 2 the surprisingly excellent adhesion between a steel cord according to the present invention using an amino silane and a modified polypropylene coating is clear.

The adhesion of the steel cords with the structure of 4×7 separately coated with nothing (steel cord A), coated with one layer of maleic anhydride grafted polypropylene (steel cord B) and coated with a first layer of amino silane and a second layer of maleic anhydride grafted polypropylene (steel cord C) to the reinforced polymer composite comprising polypropylene as thermoplastic material are compared. The steel cords A, B and C are consisting of the galvanized steel filaments with the diameter of 0.10 mm. Table 3 summarizes the results.

TABLE 3

| elongated metal element | steel cord A | steel cord B | steel cord C |
|---|---|---|---|
| embedment length (mm) | 25 | 25 | 25 |
| POF/(POF of steel cord A) | 1 | 4.87 | 8.80 |

From Table 3, it is obvious that the coating of first layer of amino silane and second layer of maleic anhydride grafted polypropylene provides the best adhesion between the steel cord and the polymer composite.

Table 1, Table 2 and Table 3 show that the elongated metal element comprising at least a first layer and a second layer presents a good adhesion with the polymer composite. The adhesion to matrix of thermoplastic material of metal element in the present invention is much better than the adhesion of metal element coated only with adhesion promoting layer, only with modified polyolefin, or with two layers of adhesion promoting layer and non-modified polyolefin layer. Such reinforced polymer composite is stable enough to be used for load bearing application, especially for housing, the telephone poles, window and door frames, scaffold boards, shore reinforcement etc.

FIG. 6 illustrates a first embodiment of the reinforced polymer composite 50 with I profile in cross-section. The polymer composite 50 comprises a matrix of polypropylene comprising wood particles with a concentration of 40% by weight, and the flat wires 22 are embedded in the matrix. The moisture of the wood particles is 0.8%. The upper flange 52 and the lower flange 54 are reinforced by the flat wires 22.

FIG. 7 illustrates a second embodiment of the reinforced polymer composite 60 with tubular profile in cross-section. The polymer composite 60 comprises a matrix of polyethylene comprising wood particles with a concentration of 70% by weight, and the steel cords 32 are embedded in the matrix. The moisture of the wood particles is 0.6%. The upper wall and the lower wall are reinforced by the steel cords 32.

1. A reinforced polymer composite comprising a matrix of thermoplastic material, said matrix being reinforced by at least one elongated metal element, characterized in that said elongated metal element before being embedded in said matrix is coated with at least a first layer and a second layer, said first layer comprises an adhesion promoting layer, and said second layer comprises a polyolefin copolymerized or grafted with at least one monomer comprising an anhydride or a carboxylic acid functional group.

2. A reinforced polymer composite as claimed in claim 1, characterized in that said matrix of thermoplastic material further comprises wood particles, said wood particles being present in a concentration ranging between 0% and 95% by weight.

3. A reinforced polymer composite as claimed in claim 1, characterized in that said anhydride comprises acid anhydride.

4. A reinforced polymer composite as claimed in claim 3, characterized in that said acid anhydride comprises maleic anhydride.

5. A reinforced polymer composite as claimed in claim 1, characterized in that said carboxylic acid functional group comprises an acrylic acid functional group.

6. A reinforced polymer composite as claimed in claim 1, characterized in that said polyolefin is polyethylene or polypropylene.

7. A reinforced polymer composite as claimed in claim 1, characterized in that said adhesion promoting layer comprises a silicon based coating, a titanium based coating or a zirconium based coating.

8. A reinforced polymer composite as claimed in claim 7, characterized in that said silicon based coating comprises a silane based coating.

9. A reinforced polymer composite as claimed in claim 1, characterized in that said thermoplastic material is selected from the group consisting of polyolefin, copolymerized polyolefin, grafted polyolefin or a combination thereof.

10. A reinforced polymer composite as claimed in claim 1, characterized in that said thermoplastic material is the same as the material of the second layer.

11. A reinforced polymer composite as claimed in claim 1, characterized in that said elongated metal element comprises at least a steel wire or a steel cord.

12. A reinforced polymer composite as claimed in claim 11, characterized in that said steel wire is a flat steel wire.

13. A reinforced polymer composite as claimed in claim 11, characterized in that said steel wire is oil tempered steel wire.

14. A reinforced polymer composite as claimed in claim 1, characterized in that said reinforced polymer composite has a shape of I-profile, H-profile, tubular profile or multiple tubular profile in cross section.

15. A method of manufacturing a reinforced polymer composite comprising the following steps,
providing at least one elongated metal element;
applying a first layer on said elongated metal element, said first layer comprising an adhesion promoting layer;
applying a second layer on top of said first layer, said second layer comprising a polyolefin copolymerized or grafted with at least one monomer comprising an anhydride or a carboxylic acid functional group;
embedding at least one said elongated metal element coated with said first layer and said second layer into a matrix of a thermoplastic material.

16. A method of manufacturing a reinforced polymer composite as claimed in claim 15, characterized in that said applying second layer on top of said first layer by applying molten said polyolefin copolymerized or grafted with at least one monomer comprising an anhydride or a carboxylic acid functional group under high pressure onto said elongated metal element through an extrusion die, or by coating with a solution or emulsion of said polyolefin copolymerized or grafted with at least one monomer comprising an anhydride or a carboxylic acid functional group on said elongated metal element and subsequently drying said coating.

17. An elongated metal element, characterized in that said elongated metal element is coated with at least a first layer and a second layer, said first layer comprises an adhesion promoting layer, and said second layer comprises a polyolefin copolymerized or grafted with at least one monomer comprising an anhydride or a carboxylic acid functional group.

18. A reinforced polymer composite as claimed in claim 2, characterized in that said anhydride comprises acid anhydride.

19. A reinforced polymer composite as claimed in claim 2, characterized in that said carboxylic acid functional group comprises an acrylic acid functional group.

20. A reinforced polymer composite as claimed in claim 12, characterized in that said steel wire is oil tempered steel wire.
